(19) United States
(12) Patent Application Publication
(10) Pub. No.: US 2026/0062524 A1
(43) Pub. Date: Mar. 5, 2026

(54) FIBER-BASED SUPPORT STRUCTURE FOR THE PRODUCTION OF FIBER COMPOSITE MATERIALS

(71) Applicant: Infinici AG, Hamburg (DE)

(72) Inventors: Peter BREUER, Greifswald (DE); Ralf-Stefan STUHR, Hamburg (DE)

(21) Appl. No.: 19/064,036

(22) Filed: Feb. 26, 2025

(30) Foreign Application Priority Data
Sep. 2, 2024 (DE) 20 2024 104 995.0

(51) Int. Cl. C08J 5/08

(52) U.S. Cl. CPC C08J 5/08

(57) ABSTRACT

A fiber-based support structure for the production of fiber composites, comprising:
a first reinforcing fiber component, and
a second reinforcing fiber component,
wherein said first reinforcing fiber component is finite fibers that are in a random arrangement, wherein said second reinforcing fiber component is finite fiber bundles having an average fiber bundle length of less than 45 mm that are in a random arrangement, wherein the fibers that constitute the fiber bundles of said second reinforcing fiber component are glass fibers, and wherein said fiber-based support structure has a pore system for soaking with a plastic matrix.

### CROSS REFERENCE TO RELATED APPLICATION

This application claims priority to German Patent Application No. 20 2024 104 995.0, filed Sep. 2, 2024, incorporated herein by reference.

The present invention relates to a fiber-based support structure for the production of fiber composites, and to a fiber composite material part, especially a fiber composite plastic part. The invention further relates to a method for producing a fiber-based support structure for the production of fiber composites.

Fiber composite materials, also known as composites, multiphase or mixed materials, generally consist of two main components: the reinforcing fibers, and an embedding “matrix” (the filler and adhesive between the fibers). Fiber composite material parts are used in many areas. They are used, for example, in furniture and household appliances, but are also used in buildings, boats, the automotive and vehicle construction industries and aerospace. The fiber composite plastic parts with the greatest economic importance are glass fiber reinforced plastics (GRP), i.e., fiber composite plastic parts that include glass fibers as reinforcing fibers. Various processes for producing fiber composite material parts are known in the prior art. One example is the so-called vacuum infusion, in which dry fiber material, such as rovings, mats, scrims or fabrics, is used. For example, if a fiber composite plastic part is to be produced using this process, the dry fiber material is placed in a mold coated with a release agent. A separating fabric and a distribution medium are placed over this, which is intended to facilitate the even flow of the resin, which later forms the bedding matrix of the fiber composite plastic part when cured. The film is sealed against the mold using a vacuum sealing tape, and the component is then evacuated using a vacuum pump (usually rotary vane pumps). The air pressure presses the inserted parts together and fixes them. The oftentimes temperature-controlled liquid resin is sucked into the fiber material by the applied vacuum. After the fibers are completely soaked, the resin supply is stopped, and the soaked fiber composite plastic part can be removed from the mold after it has hardened. The curing times depend on the chosen matrix material (resin) and the temperature.

In the method described above and in other known methods, dry fiber materials, such as the already mentioned rovings, mats, scrims or fabrics, are used as the fiber-based support structure for the embedding (resin) matrix. These dry fiber materials are also referred to as “semi-finished fiber products”.

It is common for such semi-finished fiber products to be pre-produced and only gradually processed into fiber composite materials or made available to the manufacturers of fiber composite materials.

The semi-finished fiber products should have different properties depending on the subsequent area of application of the finished fiber composite materials. Particularly in the case of semi-finished fiber products that are to be used for fiber composite materials in the automotive and vehicle construction industries, aerospace, shipbuilding, medical technology or in wind turbines, it is important that they have good soakability, i.e., that they can be soaked/impregnated well and, above all, evenly with a plastic matrix. This allows fiber composite materials to be obtained with reproducibly high quality.

In the prior art, for example, it is known to produce semi-finished fiber products in which at least some of the reinforcing fibers are arranged unidirectionally, so that an anisotropic structure in the fiber alignment results at least in the areas of the unidirectional fiber arrangement. In the areas with an anisotropic structure there is good soakability. However, the manufacturing processes for scrim-based semi-finished fiber products with an anisotropic structure are complex and cost-intensive.

There is therefore a need for further semi-finished fiber products which have good soakability, i.e., can be soaked/impregnated well and evenly with a matrix, for example a plastic matrix.

Therefore, it has been the object of the present invention to provide a fiber-based support structure for the production of fiber composite materials, which has good soakability with viscous liquids and powders and overcomes at least some of the disadvantages known from the prior art. It is a further object of the present invention to provide fiber composite material parts comprising at least one of the fiber-based support structures according to the invention. It is a further object of the present invention to provide a method for producing a fiber-based support structure for the production of fiber composites.

The object of the invention is achieved by a fiber-based support structure for the production of fiber composites, comprising:
a first reinforcing fiber component, and
a second reinforcing fiber component,
wherein said first reinforcing fiber component is finite fibers that are in a random arrangement,
wherein said second reinforcing fiber component is finite fiber bundles having an average fiber bundle length of less than 45 mm that are in a random arrangement, wherein the fibers that constitute the fiber bundles of said second reinforcing fiber component are glass fibers, and
wherein said fiber-based support structure has a pore system for soaking with a plastic matrix.

Surprisingly, it has been found that the fiber-based support structure according to the invention is particularly suitable for absorbing liquids, melts and/or solid particles due to the random arrangement of the finite fibers of the first reinforcing fiber component and the random arrangement of the finite fiber bundles of the second reinforcing fiber component with a defined average fiber bundle length of less than 45 mm and the pore system formed in the fiber-based carrier structure, and for ensuring that these liquids, melts and/or solid particles are distributed evenly over the entire fiber-based support structure.

This ensures, for example, that a larger range of materials can be used for the matrix of fiber composite materials, that soaking times can be shortened and simpler impregnation processes can be used, which advantageously reduces the production costs of fiber composite materials, and that thicker fiber-based support structures can be used (since the soakability is improved).

The fiber-based support structure according to the invention is a semi-finished fiber product.

The fiber-based support structure according to the invention comprises at least two different reinforcing fiber components. The fiber-based support structure according to the invention can therefore also include more than two different reinforcing fiber components.

The first reinforcing fiber component is finite fibers, i.e., fibers with a finite length. Said finite fibers are individual fibers. The finite fibers are in a random arrangement. This means that the finite fibers in the fiber-based support structure are in an isotropic arrangement.

The second reinforcing fiber component is finite fiber bundles, i.e., fiber bundles with a finite length. A fiber bundle includes two or more individual fibers. The second reinforcing fiber component can be mixtures of finite fiber bundles comprising different amounts of individual fibers. The finite fiber bundles have an average fiber bundle length of less than 45 mm. Like the fibers of the first reinforcing fiber component, the fiber bundles of the second reinforcing fiber component are also in a random arrangement, i.e., are in an isotropic arrangement in the fiber-based support structure.

The average fiber bundle length of the finite fiber bundles of the second reinforcing fiber component can be determined based on DIN 53808-1:2003-01. This DIN standard describes single fiber measuring methods for determining the length of finite fibers. Instead of individual fibers, fiber bundles are measured here. To determine the average fiber bundle length, the fiber bundle length of 100 randomly selected fiber bundles is determined using the method described in the standard, and the average of the measured values is determined. This average corresponds to the average fiber bundle length.

In the fiber-based support structure according to the invention, the fibers of the first reinforcing fiber component and the fiber bundles of the second reinforcing fiber component are preferably homogeneously distributed. This means that both the first and second reinforcing fiber components are evenly distributed in predominantly all areas of the fiber-based support structure, wherein it is of course possible that the total amount of the first reinforcing fiber component in the fiber-based support structure is overall greater than the total amount of the second reinforcing fiber component and vice versa. It is just that there should preferably be no areas with a significantly higher content of the first reinforcing fiber component while at the same time having areas with a significantly lower content of the first reinforcing fiber component, and preferably no areas with a significantly higher content of the second reinforcing fiber component while simultaneously having areas with a significantly lower content of the second reinforcing fiber component. However, this is not fundamentally excluded as long as there is an overall isotropic arrangement of fibers of the first reinforcing fiber component and fiber bundles of the second reinforcing fiber component.

The fibers that constitute the finite fiber bundles of the second reinforcing fiber component are glass fibers according to the invention. This means that the fiber bundles of the second reinforcing fiber component are made of glass fibers. The finite fiber bundles result from reinforcing fiber bundles or roving sections that were originally endless, but chopped to finite lengths. The finite fiber bundles of the second reinforcing fiber component can also be obtained by recycling glass fiber materials such as dry glass fiber fabrics, scrims, and/or mats.

The pore system in the fiber-based support structure according to the invention causes that the latter is suitable for being impregnated with a plastic matrix. The pore system comprises a plurality of interconnected cavities which are connected to one another by transport channels in order to be able to transport powders and/or liquids applied from the outside into the cavities.

Preferably, said support structure has a soakability with a viscous liquid having a viscosity within a range of from 60 to 120 mPa·s of from 1.5 to 10.0 cm/min, preferably from 2.0 to 5.0 cm/min, respectively determined in a vacuum infusion method. According to the invention, the soakability of the fiber-based support structure is determined in the vacuum infusion process by determining the flow distance that a liquid resin front covers in the fiber-based support structure in question in a defined time during a vacuum infusion. To determine the soakability, the fiber-based support structure is placed in a transparent tray, sealed to be vacuum-tight, and a vacuum (−0.9 mbar) is applied to one side of the fiber-based support structure, whereby the carrier resin, e.g., Enydyne I-69277-A (pre-accelerated polyester resin; manufacturer: Polynt, Germany)/Butanox M-50 (methyl ethyl ketone peroxide for curing pre-accelerated polyester resins; manufacturer: AkzoNobel Functional Chemicals B.V., Netherlands) in a mixing ratio of 100:2 [m/m], is sucked into the fiber-based support structure. The flow distance (starting from the outer edge of the fiber-based support structure, which is opposite the side where the vacuum is applied) that the liquid resin front covers in a defined time of e.g. 10 minutes is measured. The pot life (time in which the resin is liquid) must be taken into account. The quotient of the flow distance traveled and the defined time results in the soakability of the fiber-based support structure (in cm/min).

In a preferred embodiment, the fiber-based support structure is in the form of a mechanically consolidated mat, which is preferably obtainable by forming a blend comprising the first and second reinforcing fiber components into a continuous web and then needling the blend to form a mechanically consolidated mat.

The fibers of said first reinforcing fiber component are individual fibers. The fibers of said first reinforcing fiber component preferably have an average fiber length of less than 50 mm, preferably of ≤45 mm, preferably from 20 mm to less than 45 mm, more preferably from 25 mm to 40 mm, respectively determined according to DIN 53808-1:2003-01. The fibers of the first reinforcing fiber component can be glass fibers, carbon fibers, ceramic fibers, aramid fibers, boron fibers, basalt fibers, steel fibers, natural fibers, nylon fibers or mixtures of two or more of the aforementioned. The ceramic fibers are preferably selected from the group consisting of aluminum oxide fibers, mullite fibers, SiBCN fibers, SiCN fibers and SiC fibers. The natural fibers are preferably selected from the group consisting of wood fibers, flax fibers, hemp fibers, jute fibers, kenaf fibers, ramie fibers, sisal fibers and cellulose fibers. The fibers of said first reinforcing fiber component are glass fibers, more preferably recycling glass fibers from a mechanical recycling process.

According to the invention, the finite fiber bundles of said second reinforcing fiber component have an average fiber bundle length of less than 45 mm. Preferably, the finite fiber bundles of said second reinforcing fiber component have an average fiber bundle length of from 20 mm to less than 45 mm, preferably from 25 mm to 40 mm. The average fiber bundle length can be determined as described above.

The finite fiber bundles of said second reinforcing fiber component are finite strands including at least two individual fibers. The second reinforcing fiber component can, for example, comprise finite fiber bundles comprising at least 20 individual fibers.

The individual fibers in the fiber bundles of the second reinforcing fiber component are preferably aligned parallel to one another over at least 50% of their lengths, and adhere to one another in a mechanically detachable way over at least 50% of their lengths, preferably adhering to one another in a mechanically detachable way through binders or sizes.

In a preferred embodiment, the fibers of said first reinforcing fiber component and the fibers that constitute the fiber bundles of said second reinforcing fiber component are glass fibers, preferably recycling glass fibers from a mechanical recycling process. In this embodiment, these are individual glass fibers (first reinforcing fiber component) and glass fiber bundles (second reinforcing fiber component), which can preferably be obtained in mechanical glass fiber recycling processes. If glass fiber materials such as woven, scrub and/or mat sections or roving sections are subjected to a mechanical recycling process, a mixture of the fibers of the first reinforcing fiber component and fiber bundles of the second reinforcing fiber component used for the fiber-based support structures according to the invention can be obtained. For this purpose, the glass fiber materials to be recycled are first mechanically pre-shredded to a uniform size. They are then partially separated by roughly opening them so that a mixture of glass fiber bundles and individual glass fibers is created. It is understood that such a mixture can be used to produce fiber-based support structures according to the invention. For this purpose, the mixtures can, for example, be arranged into a loose, uniform fiber layer with a random arrangement of the mixture of individual fibers and fiber bundles as a continuous web, and mechanically consolidated by needling.

The fibers of said first reinforcing fiber component and the fiber bundles of said second reinforcing fiber component in the fiber-based support structure according to the invention are preferably in a mass ratio of from 20:80 to 80:20, more preferably from 40:60 to 60:40. Preferably, the fiber-based support structure according to the invention gravimetrically comprises more finite fiber bundles than finite fibers. It was surprisingly found that a higher proportion of the fiber bundles used with an average fiber bundle length of less than 45 mm improves the soakability of the fiber-based support structure.

Preferably, the total amount of said first and second reinforcing fiber components in said fiber-based support structure is at least 50% by weight, preferably at least 60% by weight, more preferably at least 70% by weight, more preferably at least 80% by weight, more preferably at least 90% by weight, more preferably at least 95% by weight, the percentages by weight being respectively based on the total weight of said fiber-based support structure. The fiber-based support structure can also consist of 100% by weight (based on the total weight of the fiber-based support structure) of first and second reinforcing fiber components.

In one embodiment of said fiber-based support structure according to the invention, said fiber-based support structure additionally comprises at least one third reinforcing fiber component, which is also in a random arrangement, and which is finite individual fibers, finite fiber bundles, or a blend of the aforementioned.

The third reinforcing fiber component is preferably selected from the group consisting of carbon fibers, ceramic fibers, aramid fibers, boron fibers, basalt fibers, steel fibers, natural fibers, nylon fibers, and mixtures of two or more of the aforementioned. The ceramic fibers are preferably selected from the group consisting of aluminum oxide fibers, mullite fibers, SiBCN fibers, SiCN fibers and SiC fibers. The natural fibers are preferably selected from the group consisting of wood fibers, flax fibers, hemp fibers, jute fibers, kenaf fibers, ramie fibers, sisal fibers and cellulose fibers.

Preferably, said third reinforcing fiber component is carbon fibers.

Preferably, the amount of said third reinforcing fiber component in said fiber-based support structure is at most 50% by weight, preferably at most 40% by weight, more preferably at most 30% by weight, more preferably at most 20% by weight, more preferably at most 10% by weight, more preferably at most 5% by weight, the percentages by weight being respectively based on the total weight of said fiber-based support structure.

In one embodiment, the amount of the third reinforcing fiber component in the fiber-based support structure is 25% by weight, and the total amount of the first and second reinforcing fiber components is 75% by weight, the percentages by weight being respectively based on the total weight of said fiber-based support structure.

Said fiber-based support structure according to the invention preferably has a grammage of from 400 to 1000 g/m², preferably from 450 to 900 g/m², more preferably from 500 to 800 g/m², respectively determined according to DIN EN 29073-1:1992-08.

Preferably, said fiber-based support structure according to the invention is a mechanically consolidated mat having a thickness of from 4.0 to 12.0 mm, preferably from 5.0 to 11.0 mm, more preferably from 6.0 to 10.0 mm, respectively determined according to DIN EN ISO 9073-2-A:1997-02.

Preferably, the pore system of said fiber-based support structure according to the invention is open-cell in nature and openly accessible from the outside. Preferably, the plastic matrix with which the pore system can be soaked/impregnated is viscous or powdery. “Viscous” here means “having a viscosity in the range between 60 and 120 mPa·s”.

Preferably, the fiber-based support structure is a semi-finished fiber product for fiber composite material parts, especially for fiber composite plastic parts.

The invention further relates to a method for producing a fiber-based support structure according to the invention. Accordingly, the invention relates to a method for producing a fiber-based support structure for the production of fiber composites, comprising:
providing a blend comprising a first reinforcing fiber component and a second reinforcing fiber component,
consolidating the blend and thereby forming the fiber-based support structure having a pore system for soaking with a plastic matrix,
   wherein the said first reinforcing fiber component is finite fibers that are in a random arrangement, wherein the said second reinforcing fiber component is finite fiber bundles having an average fiber bundle length of less than 45 mm that are in a random arrangement, and
   wherein the fibers that constitute the fiber bundles of the said second reinforcing fiber component are glass fibers.

Preferably, the consolidating the blend comprises needling the blend. Preferably, the blend is provided as a continuous web. By needling the continuous web, a mechanically consolidated mat may be formed.

In a preferred embodiment, the fibers of said first reinforcing fiber component and the fibers that constitute the fiber bundles of said second reinforcing fiber component are glass fibers, preferably recycling glass fibers from a mechanical recycling process. If glass fiber materials such as woven, scrub and/or mat sections or roving sections are subjected to a mechanical recycling process, a blend of the fibers of the first reinforcing fiber component and fiber bundles of the second reinforcing fiber component can be obtained. For this purpose, the glass fiber materials to be recycled are first mechanically pre-shredded to a uniform size. They are then partially separated by roughly opening them so that a mixture or blend of glass fiber bundles and individual glass fibers is created. It is understood that such a blend can be used in the method according to the invention. For this purpose, the blend can, for example, be arranged into a loose, uniform fiber layer with a random arrangement of the individual fibers and fiber bundles as a continuous web, and mechanically consolidated by needling.

If the produced fiber-based support structure additionally comprises a third reinforcing fiber component, the said third reinforcing fiber component may be blended into the blend comprising the first and the second reinforcing fiber component during the production method. Alternatively, it is possible to provide a blend comprising the first, the second, and the third reinforcing fiber component in the first step of the method.

The invention also relates to the use of a fiber-based support structure according to the invention as a semi-finished fiber product for fiber composite material parts, especially fiber composite plastic parts.

The invention further relates to a fiber composite material part, in particular a fiber composite plastic part, comprising at least one fiber-based support structure according to the invention.

The fiber composite material part according to the invention can comprise one or two or more of the fiber-based support structures according to the invention. Preferably, it includes one of the fiber-based support structures according to the invention. In addition, the fiber composite material part can comprise an embedding matrix. This embedding matrix can advantageously penetrate particularly well into the fiber-based support structure according to the invention. This is preferably a plastic matrix, so that a fiber composite plastic part is preferably obtained.

The invention further relates to a method for producing a fiber composite material part, especially a fiber composite plastic part, according to the invention, comprising:
providing at least one fiber-based support structure according to the invention,
contacting the at least one fiber-based support structure with a plastic matrix.

The plastic matrix (which may be a liquid, a melt and/or solid particles) may be soaked into the pore system of the fiber-based support structure and forms the embedding matrix.

The invention also relates to the use of a fiber composite material part, especially a fiber composite plastic part, according to the invention as a component in the automotive and vehicle construction industries, aerospace industry, shipbuilding, medical technology, or in wind turbines.

Unless stated otherwise, all volumes are measured at 23° C.

It is understood that preferred embodiments or preferred features mentioned for one embodiment also apply in the same way to all other embodiments mentioned in the application. Each preferred embodiment and each preferred feature can be combined with one another without further limitation.

The invention is explained in more detail by the following examples, but without limiting the scope of protection to these specific examples:

### EXAMPLES

### Example 1—Production of a Fiber-Based Support Structure from Recycled Glass Fibers

Dry glass fiber fabrics, glass fiber scrims, and glass fiber mat sections were pre-shredded to a uniform size through cutting processes. The pieces of uniform size were then partially separated by roughly opening them, resulting in a mixture of glass fiber bundles and individual glass fibers in a mass ratio of 60:40. The glass fiber bundles in the mixture included, among other things, glass fiber bundles with at least 20 individual fibers. The mixture was formed into a loose, uniform fiber layer with a random arrangement/orientation of the mixture of individual fibers and fiber bundles with a grammage of 650 g/m², drawn off as a continuous web, and then mechanically consolidated by needling.

The properties of the glass fiber mat obtained from recycled glass fibers (100% by weight of glass fiber) are shown in the following Table 1:

TABLE 1
Properties of the glass fiber mat according to Example 1.

| Parameter | Measured value |
|---|---|
| Average fiber bundle length [mm]* | 36 |
| Soakability [cm/min]** | 2.5 |
| Thickness [mm]*** | 8.0 |
| Grammage [g/m²]**** | 650 |

*determined based on DIN 53808-1: 2003-01 on 100 randomly selected fiber bundles from the mixture of fiber bundles and individual fibers obtained in the example.
**Soakability with a viscous liquid which has a viscosity in the range between 60 and 120 mPa s, according to the vacuum infusion method described in the application by determining the flow distance of a liquid resin front in a defined time of 10 minutes during a vacuum infusion.
***as determined according to DIN EN ISO 9073-2-A: 1997-02.
****as determined according to DIN EN 29073-1: 1992-08.

Surprisingly, it has been found that the glass fiber mat obtained had excellent soakability with liquid resin (Enydyne I-69277-A (pre-accelerated polyester resin; manufacturer: Polynt, Germany)/Butanox M-50 (methyl ethyl ketone peroxide for curing pre-accelerated polyester resins; manufacturer: AkzoNobel Functional Chemicals B.V., Netherlands) in a mixing ratio of 100:2 [m/m]). It was also found that the glass fiber mat was evenly soaked with the liquid resin. The soakability of 2.5 cm/min means that the time required to completely soak the glass fiber mat is also advantageously short. The glass fiber mats obtained in Example 1 are therefore particularly suitable for cost-effectively producing high-quality components for the automobile and vehicle construction industries, aerospace, shipbuilding, medical technology or for wind turbines.

### Example 2—Production of a Fiber-Based Support Structure from Recycled Glass Fibers and Carbon Fibers

Dry glass fiber fabrics, glass fiber scrims, and glass fiber mat sections were pre-shredded to a uniform size through cutting processes as in Example 1. The pieces of uniform size were then partially separated by roughly opening them, resulting in a mixture of glass fiber bundles and individual glass fibers in a mass ratio of 60:40. The glass fiber bundles in the mixture included, among other things, glass fiber bundles with at least 20 individual fibers.

A mixture of the glass fiber mixture and carbon fibers was produced. The mixture consisted of 75% by weight of the glass fiber mixture and 25% by weight of the carbon fibers (% by weight based on the total weight of the mixture). This glass fiber-carbon fiber mixture was drawn off into a loose, uniform fiber layer with a random arrangement/orientation of the mixture of glass fiber individual fibers, glass fiber bundles and carbon fibers with a grammage of 650 g/m², formed as an endless web and then mechanically consolidated by needling.

The properties of the resulting glass fiber-carbon fiber mat comprising recycled glass fibers (75% by weight of glass fiber; 25% by weight of carbon fiber) are shown in the following Table 2:

TABLE 2
Properties of the glass fiber/carbon
fiber mat according to Example 2.

| | Measured |
|---|---|
| Parameter | value |
| Average fiber bundle length of glass fiber bundle [mm]* | 36 |
| Soakability [cm/min]** | 3.0 |
| Thickness [mm]*** | 8.0 |
| Grammage [g/m²]**** | 650 |

*determined based on DIN 53808-1: 2003-01 on 100 randomly selected fiber bundles from the mixture of fiber bundles and individual fibers obtained in the example.
**Soakability with a viscous liquid which has a viscosity in the range between 60 and 120 mPa s, according to the vacuum infusion method described in the application by determining the flow distance of a liquid resin front in a defined time of 10 minutes during a vacuum infusion.
***as determined according to DIN EN ISO 9073-2-A: 1997-02.
****as determined according to DIN EN 29073-1: 1992-08.

Surprisingly, it has been found that the glass fiber/carbon fiber mat obtained had excellent soakability with liquid resin (Enydyne I-69277-A (pre-accelerated polyester resin; manufacturer: Polynt, Germany)/Butanox M-50 (methyl ethyl ketone peroxide for curing pre-accelerated polyester resins; manufacturer: AkzoNobel Functional Chemicals B.V., Netherlands) in a mixing ratio of 100:2 [m/m]). It was also found that the glass fiber/carbon fiber mat was evenly soaked with the liquid resin. The soakability of 3.0 cm/min means that the time required to completely soak the glass fiber/carbon fiber mat is also advantageously short. The glass fiber/carbon fiber mats obtained in Example 2 are therefore particularly suitable for cost-effectively producing high-quality components for the automobile and vehicle construction industries, aerospace, shipbuilding, medical technology or for wind turbines.

### Preferred Items:

1. A fiber-based support structure for the production of fiber composites, comprising:
   a first reinforcing fiber component, and
   a second reinforcing fiber component,
   wherein said first reinforcing fiber component is finite fibers that are in a random arrangement, wherein said second reinforcing fiber component is finite fiber bundles having an average fiber bundle length of less than 45 mm that are in a random arrangement, wherein the fibers that constitute the fiber bundles of said second reinforcing fiber component are glass fibers, and wherein said fiber-based support structure has a pore system for soaking with a plastic matrix.
2. The fiber-based support structure according to item 1, wherein said fiber-based support structure has a soakability with a viscous liquid having a viscosity within a range of from 60 to 120 mPa·s of from 1.5 to 10.0 cm/min as determined in a vacuum infusion method.
3. The fiber-based support structure according to item 1 or 2, wherein said fiber-based support structure is in the form of a mechanically consolidated mat, which is preferably obtainable by forming a blend comprising the first and second reinforcing fiber components into a continuous web, followed by needling the blend to form a mechanically consolidated mat.
4. The fiber-based support structure according to any one of items 1 to 3, wherein the fibers of said first reinforcing fiber component are individual fibers.
5. The fiber-based support structure according to any one of items 1 to 4, wherein the fibers of said first reinforcing fiber component have an average fiber length of less than 50 mm, preferably of ≤45 mm, preferably from 20 mm to less than 45 mm, more preferably from 25 mm to 40 mm, respectively determined according to DIN 53808-1:2003-01.
6. The fiber-based support structure according to any one of items 1 to 5, wherein the fiber bundles of said second reinforcing fiber component have an average fiber bundle length of from 20 mm to less than 45 mm, preferably from 25 mm to 40 mm.
7. The fiber-based support structure according to any one of items 1 to 6, wherein the fiber bundles of said second reinforcing fiber component are finite length strands comprising at least two individual fibers.
8. The fiber-based support structure according to any one of items 1 to 7, wherein the individual fibers in the fiber bundles of said second reinforcing fiber component are oriented in parallel to one another over at least 50% of their lengths, and adhere to one another in a mechanically detachable way over said at least 50% of their lengths, in which they preferably adhere to one another in a mechanically detachable way by using binders or sizes.
9. The fiber-based support structure according to any one of items 1 to 8, wherein the fibers of said first reinforcing fiber component and the fiber bundles of said second reinforcing fiber component are in a mass ratio of from 20:80 to 80:20, preferably from 40:60 to 60:40.
10. The fiber-based support structure according to any one of items 1 to 9, wherein the fibers of said first reinforcing fiber component and the fibers that constitute the fiber bundles of said second reinforcing fiber component are glass fibers, preferably recycling glass fibers from a mechanical recycling process.
11. The fiber-based support structure according to any one of items 1 to 10, wherein the total amount of said first and second reinforcing fiber components in said fiber-based support structure is at least 50% by weight, preferably at least 60% by weight, more preferably at least 70% by weight, more preferably at least 80% by weight, more preferably at least 90% by weight, more preferably at least 95% by weight; the percentages by weight being respectively based on the total weight of said fiber-based support structure.
12. The fiber-based support structure according to any one of items 1 to 11, wherein said fiber-based support structure additionally comprises at least one third reinforcing fiber component, which is also in a random arrangement, and which is finite individual fibers, finite fiber bundles, or a blend of the aforementioned.
13. The fiber-based support structure according to item 12, wherein said third reinforcing fiber component is selected from the group consisting of carbon fibers, ceramic fibers, aramid fibers, boron fibers, basalt fibers, steel fibers, natural fibers, nylon fibers, and blends of two or more of the aforementioned.
14. The fiber-based support structure according to item 13, wherein said ceramic fibers are selected from the group consisting of alumina fibers, mullite fibers, SiBCN fibers, SiCN fibers, and SiC fibers.
15. The fiber-based support structure according to item 13, wherein said natural fibers are selected from the group consisting of wood fibers, flax fibers, hemp fibers, jute fibers, kenaf fibers, ramie fibers, sisal fibers, and cellulose fibers.
16. The fiber-based support structure according to item 13, wherein said third reinforcing fiber component is carbon fibers.
17. The fiber-based support structure according to any one of items 12 to 16, wherein the amount of said third reinforcing fiber component in said fiber-based support structure is at most 50% by weight, preferably at most 40% by weight, more preferably at most 30% by weight, more preferably at most 20% by weight, more preferably at most 10% by weight, more preferably at most 5% by weight; the percentages by weight being respectively based on the total weight of said fiber-based support structure.
18. The fiber-based support structure according to any one of items 1 to 17, wherein said fiber-based support structure has a grammage of from 400 to 1000 g/m², preferably from 450 to 900 g/m², more preferably from 500 to 800 g/m², respectively determined according to DIN EN 29073-1:1992-08.
19. The fiber-based support structure according to any one of items 1 to 18, wherein said fiber-based support structure is a mechanically consolidated mat having a thickness of from 4.0 to 12.0 mm, preferably from 5.0 to 11.0 mm, more preferably from 6.0 to 10.0 mm, respectively determined according to DIN EN ISO 9073-2-A:1997-02.
20. The fiber-based support structure according to any one of items 1 to 19, wherein the pore system is open-cell in nature and openly accessible from the outside.
21. The fiber-based support structure according to any one of items 1 to 20, wherein the plastic matrix is viscous or powdery.
22. A fiber composite material part, especially a fiber composite plastic part, comprising at least one fiber-based support structure according to any one of items 1 to 21.
23. Use of a fiber-based support structure according to any one of items 1 to 21 as a semi-finished fiber product for fiber composite material parts, especially fiber composite plastic parts.
24. Use of a fiber composite material part, especially a fiber composite plastic part, according to item 22 as a component in the automotive and vehicle construction industries, aerospace industry, shipbuilding, medical technology, or in wind turbines.

What is claimed is:

1. A fiber-based support structure for the production of fiber composites, comprising:
a first reinforcing fiber component, and
a second reinforcing fiber component,
wherein the said first reinforcing fiber component is finite fibers that are in a random arrangement, wherein the said second reinforcing fiber component is finite fiber bundles having an average fiber bundle length of less than 45 mm that are in a random arrangement, wherein the fibers that constitute the fiber bundles of the said second reinforcing fiber component are glass fibers, and wherein the said fiber-based support structure has a pore system for soaking with a plastic matrix.

2. The fiber-based support structure according to claim 1, wherein the said fiber-based support structure has a soakability with a viscous liquid having a viscosity within a range of from 60 to 120 mPa·s of from 1.5 to 10.0 cm/min as determined in a vacuum infusion method.

3. The fiber-based support structure according to claim 1, wherein the said fiber-based support structure is in the form of a mechanically consolidated mat.

4. The fiber-based support structure according to claim 1, wherein the fibers of the said first reinforcing fiber component are individual fibers.

5. The fiber-based support structure according to claim 1, wherein the fibers of the said first reinforcing fiber component have an average fiber length of less than 50 mm, determined according to DIN 53808-1:2003-01.

6. The fiber-based support structure according to claim 1, wherein the fiber bundles of the said second reinforcing fiber component have an average fiber bundle length of from 20 mm to less than 45 mm.

7. The fiber-based support structure according to claim 1, wherein the fiber bundles of the said second reinforcing fiber component are finite length strands comprising at least two individual fibers.

8. The fiber-based support structure according to claim 1, wherein the individual fibers in the fiber bundles of the said second reinforcing fiber component are oriented in parallel to one another over at least 50% of their lengths, and adhere to one another in a mechanically detachable way over said at least 50% of their lengths.

9. The fiber-based support structure according to claim 1, wherein the fibers of the said first reinforcing fiber component and the fiber bundles of the said second reinforcing fiber component are in a mass ratio of from 20:80 to 80:20.

10. The fiber-based support structure according to claim 1, wherein the fibers of the said first reinforcing fiber component and the fibers that constitute the fiber bundles of the said second reinforcing fiber component are glass fibers.

11. The fiber-based support structure according to claim 10, wherein the fibers of the said first reinforcing fiber component and the fibers that constitute the fiber bundles of the said second reinforcing fiber component are recycling glass fibers from a mechanical recycling process.

12. The fiber-based support structure according to claim 1, wherein the total amount of the said first and second reinforcing fiber components in the said fiber-based support structure is at least 50% by weight; the percentage by weight being based on the total weight of the said fiber-based support structure.

13. The fiber-based support structure according to claim 1, wherein the said fiber-based support structure additionally comprises at least one third reinforcing fiber component, which is also in a random arrangement, and which is finite individual fibers, finite fiber bundles, or a blend of the aforementioned.

14. The fiber-based support structure according to claim 13, wherein the said third reinforcing fiber component is selected from the group consisting of carbon fibers, ceramic fibers, aramid fibers, boron fibers, basalt fibers, steel fibers, natural fibers, nylon fibers, and blends of two or more of the aforementioned.

15. The fiber-based support structure according to claim 13, wherein the amount of the said third reinforcing fiber component in the said fiber-based support structure is at most 50% by weight; the percentage by weight being based on the total weight of the said fiber-based support structure.

16. The fiber-based support structure according to claim 1, wherein the said fiber-based support structure
(i) has a grammage of from 400 to 1000 g/m², determined according to DIN EN 29073-1:1992-08; and/or
(ii) is a mechanically consolidated mat having a thickness of from 4.0 to 12.0 mm, determined according to DIN EN ISO 9073-2-A:1997-02.

17. The fiber-based support structure according to claim 1, wherein the said fiber-based support structure is a semi-finished fiber product for fiber composite material parts.

18. A method for producing a fiber-based support structure, comprising:
providing a blend comprising a first reinforcing fiber component and a second reinforcing fiber component,
consolidating the blend and thereby forming the fiber-based support structure having a pore system for soaking with a plastic matrix,
wherein the said first reinforcing fiber component is finite fibers that are in a random arrangement, wherein the said second reinforcing fiber component is finite fiber bundles having an average fiber bundle length of less than 45 mm that are in a random arrangement, and wherein the fibers that constitute the fiber bundles of the said second reinforcing fiber component are glass fibers.

19. The method according to claim 18, wherein the consolidating the blend comprises needling the blend.

20. A fiber composite material part comprising at least one fiber-based support structure according to claim 1.
